(19) United States
(12) Patent Application Publication
(10) Pub. No.: US 2019/0144305 A1
(43) Pub. Date: May 16, 2019

(54) ADSORPTION AND REMOVAL OF HEAVY METAL IONS FROM WATER BY TRANSITION METAL DICHALCOGENIDES

(71) Applicants: Qing Hua Wang, Scottsdale, AZ (US); Duo Li, Tempe, AZ (US); Matthew Gilliam, Tempe, AZ (US); Alexander A. Green, Scottsdale, AZ (US)

(72) Inventors: Qing Hua Wang, Scottsdale, AZ (US); Duo Li, Tempe, AZ (US); Matthew Gilliam, Tempe, AZ (US); Alexander A. Green, Scottsdale, AZ (US)

(21) Appl. No.: 16/191,006

(22) Filed: Nov. 14, 2018

Related U.S. Application Data
(60) Provisional application No. 62/585,935, filed on Nov. 14, 2017.

(51) Int. Cl. C02F 1/28; B01J 20/02; B01J 20/26; B01J 20/24; B01J 20/28; B01J 20/30

(52) U.S. Cl. CPC C02F 1/288; B01J 20/0266; B01J 20/0218; B01J 20/262; B01J 20/24; B01J 20/28026; C02F 2101/20; B01J 20/28047; B01J 20/3085; C02F 1/281; C02F 1/285; C02F 1/286; B01J 20/28016

(57) ABSTRACT

Removing heavy metal ions from an aqueous composition includes contacting an aqueous composition including a heavy metal with nanoflakes comprising MoS₂ for a length of time sufficient to form nanoclusters of the heavy metal on the nanoflakes. A composite may include a porous polymeric matrix and MoS₂ nanoflakes coupled to the porous polymeric matrix. Making a porous MoS₂-polymer composite may include combining a solution phase dispersion of MoS₂ with a polymer precursor solution to yield a mixture, treating the polymer precursor solution to yield a composite precursor, and drying the composite precursor to yield a porous MoS₂-polymer composite.

### CROSS-REFERENCE TO RELATED APPLICATION

This application claims the benefit of U.S. Application No. 62/585,935 entitled “ADSORPTION AND REMOVAL OF HEAVY METAL IONS FROM WATER BY TRANSITION METAL DICHALCOGENIDES” and filed on Nov. 14, 2017, which is incorporated herein by reference in its entirety.

### TECHNICAL FIELD

This invention relates to adsorption and removal of heavy metal ions from water by transition metal dichalcogenides.

### BACKGROUND

Heavy metals including Pb, As, Hg and Cd are hazardous to human health, and can be found as contaminants in water supplies from either industrial or household sources such as paints, plumbing, and factory emissions. These metals are regulated to stay below critical levels in drinking water based on the onset of harmful physiological effects such as organ damage caused by Cd poisoning and developmental delay in children caused by Pb poisoning. However, current commercial techniques for removing heavy metals from water such as ion-exchange resins, reverse osmosis, and activated carbon either have unstable performance or are expensive, and many of them operate most effectively at fairly high heavy metal concentrations rather than at the trace levels where harmful physiological effects begin. Thus, new techniques for removing trace amounts of heavy metals from water remain a pressing need.

### SUMMARY

In a first general aspect, removing heavy metal ions from an aqueous composition includes contacting an aqueous composition including a heavy metal with nanoflakes comprising MoS₂ for a length of time sufficient to form nanoclusters of the heavy metal on the nanoflakes.

Implementations of the first general aspect may include one or more of the following features.

The nanoflakes may be heated to desorb the heavy metal from the nanoflakes. Heating the nanoflakes may include heating the nanoflakes to a temperature of at least 200° C. for at least one hour in an inert atmosphere. The nanoflakes may include monolayer, bilayer, or trilayer MoS₂. The nanoflakes may be coupled to a porous polymer matrix. The matrix may include polyurethane or a biopolymer (e.g., chitosan, alginate, and cellulose).

The heavy metal may include one or more of lead, zinc, cadmium, and cobalt. A concentration of the heavy metal in the aqueous composition may be between 100 parts per billion and 500 parts per million, or between 100 parts per billion and 100 parts per million. The nanoclusters typically have a dimension in a range between 2 nm and 100 nm. At least 50 wt %, at least 70 wt %, or at least 90 wt % of the heavy metal may be removed from the aqueous composition.

In a second general aspect, a composite includes a porous polymeric matrix and MoS2 nanoflakes coupled to the porous polymeric matrix.

Implementations of the second general aspect may include one or more of the following features.

The porous polymeric matrix may include polyurethane or a biopolymer (e.g., chitosan, alginate, and cellulose). In one example, the biopolymer includes chitosan, and the composite is in the form of chitosan-containing beads. The chitosan-containing beads can be in the form of a xerogel or an aerogel.

In a third general aspect, making a porous MoS₂-polymer composite includes combining a solution phase dispersion of MoS₂ with a polymer precursor solution to yield a mixture, treating the polymer precursor solution to yield a composite precursor, and drying the composite precursor to yield a porous MoS₂-polymer composite.

Implementations of the third general aspect may include one or more of the following features.

The polymer precursor solution may include chitosan. In some cases, the porous MoS₂-polymer composite is in the form of an aerogel.

The adsorption of the heavy metals Pb, Cd, Zn and Co from aqueous solution on the surface of two-dimensional (2D) molybdenum disulfide (MoS₂) is demonstrated using atomic force microscopy (AFM), scanning electron microscopy (SEM), and elemental analysis by X-ray photoelectron spectroscopy (XPS). The metals form nanoclusters on the MoS₂ surface without affecting the structure of the MoS₂ itself. The metals can be readily desorbed from the MoS₂ surface by thermal annealing. The ability to adsorb metals from aqueous solution at low concentrations and then to thermally desorb them is indicative of a regenerable water purification material. In one example, a composite foam is synthesized from MoS₂ and polyurethane. The composite foam demonstrates effective removal of Pb from water, with up to 89% removal efficiency at concentrations below 200 ppb.

### BRIEF DESCRIPTION OF THE DRAWINGS

FIG. 1 depicts adsorption of metal ions on MoS₂.

FIGS. 2A-2D show X-ray photoelectron spectroscopy (XPS) spectra of MoS₂ grown by chemical vapor deposition from top to bottom: as-grown, and after immersion in aqueous solutions of Cd, Zn and Pb nitrates, respectively, at 10 mM concentrations for 30 min. The spectra are vertically offset for clarity. FIG. 2A shows Mo3p, N 1s, and Cd 3d peaks. FIG. 2B shows Mo 3d peaks. FIG. 2C shows S 2p peaks. FIG. 2D shows Zn 2p peaks (upper) and Pb 4f peaks (lower).

FIG. 3 depicts thermal desorption of metals from a MoS₂ surface by heating in a tube furnace.

FIG. 4 shows Raman spectra of pristine as-exfoliated MoS₂ monolayer (lower curve) and Pd adsorbed MoS₂ monolayer after thermal desorption (upper curve). The characteristic E¹_{2g} and A_{1g} peaks of MoS₂ are marked.

FIG. 5 depicts forming three-dimensional (3D) structures with two-dimensional (2D). MoS₂.

FIG. 6 shows Raman spectra taken from MoS₂-polyurethane composite foam (upper curve) and unmodified polyurethane foam (lower curve). The characteristic E¹_{2g} and A_{1g} peaks of MoS₂ are marked.

FIGS. 7A and 7B show adsorption efficiencies of Pb solutions and Zn solutions, respectively, for polyurethane and MoS₂-polyurethane composite foam

FIGS. 8A and 8B show adsorption efficiencies of Cd and Co, respectively, for polyurethane and MoS₂-polyurethane composite foam.

FIG. 9 depicts chemical vapor deposition (CVD) growth of polycrystalline MoS₂.

FIGS. 10A-10D show height profiles along selected lines in AFM images before (lower trace) and after (upper trace) Pb adsorption.

### DETAILED DESCRIPTION

The effectiveness of MoS₂ for adsorbing metals is described, as well as the performance of MoS₂ for water purification in a macroscopic composite structure. Heavy metals Pb, Zn, Cd, and Co from aqueous solution are adsorbed on the surface of two-dimensional (2D) MoS₂, and the presence of adsorbed metals is verified by elemental analysis. The metals deposit as nanoclusters on the MoS₂ surface, which can be desorbed by thermal annealing. A porous MoS₂-polyurethane composite foam with high specific surface area is prepared for use as an adsorbent material in water purification. This MoS₂-polyurethane composite foam can be used for removal of Pb from water with up to 89% removal efficiency at trace concentrations.

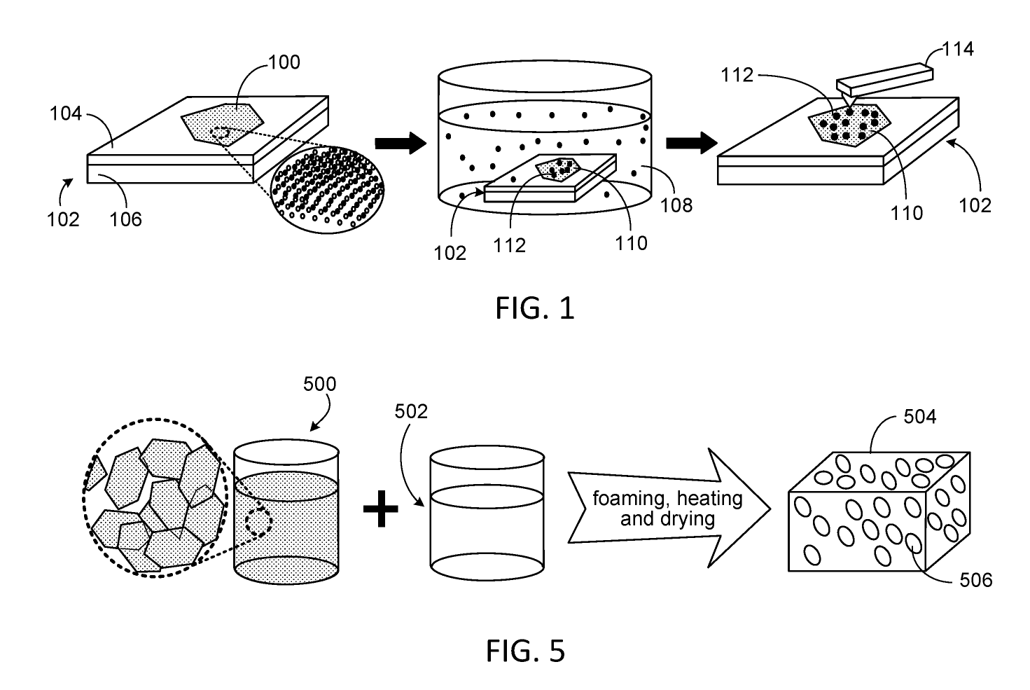

The adsorption of Pb, Cd, Zn and Co on MoS₂ monolayers from aqueous solution was investigated by atomic force microscopy (AFM) using the process depicted in FIG. 1. As depicted in FIG. 1, mechanically exfoliated MoS₂ flakes 100 supported on substrates 102 including SiO₂ layer 104 and Si 106 were immersed in a 0.1 mM aqueous solution of metal nitrates 108, including Pb, Co, Zn, and Cd nitrates, with the metal ions having a valency of +2. After exposure to the metal ion solutions, MoS₂ sample 110 with adsorbed metal 112 was rinsed with micropure water (18.2 MΩ) and blown dry with ultrahigh purity nitrogen. Atomic force microscope (AFM) 114 imaging demonstrated that Pb, Co, Zn, and Cd all have good adsorption on MoS₂.

AFM images of the pristine as-exfoliated MoS₂ surface revealed monolayer, bilayer and trilayer regions. After immersion in a lead nitrate (Pb(NO₃)₂) solution at 0.1 mM concentration followed by rinsing and drying, AFM imaging reveals small nanometer-tall protrusions on the MoS₂ surface, and not on the surrounding SiO₂ substrate. Similarly, after Cd and Zn deposition from Cd(NO₃)₂ and Zn(NO₃)₂ aqueous solutions at the same 0.1 mM concentration, small protrusions (1-2 nm tall) are found on MoS₂ surface. In addition, some larger protrusions (8-10 nm tall), attributed to be Pb and Zn clusters, are visible after MoS₂ was immersed in Pb and Zn solutions. After exposure in Co, there are also some much larger clusters of about 25-30 nm in height and 50-100 nm in diameter. These protrusions were also confirmed by scanning electron microscopy (SEM). The clusters observed are not believed to be due to supersaturation of the solution, because the concentration of the Co(NO₃)₂ solution used is several orders of magnitude lower than the solubility of Co (5.408 M at 18° C.). In addition, the samples were thoroughly rinsed with micropure water, and no protrusions or clusters were observed on the surrounding SiO₂.

Elemental analysis by X-ray photoelectron spectroscopy (XPS) was conducted after the metal adsorption from aqueous solutions to confirm the presence of metal ions on MoS₂, and to determine that the nitrate ions are not adsorbed. Continuous polycrystalline MoS₂ films were prepared by chemical vapor deposition (CVD) growth to accommodate the X-ray spotsize. The resulting MoS₂ thin films grown on SiO₂/Si were 2 to 4 nm in thickness. Separate samples of MoS₂ were each dipped in metal nitrate solutions of Cd, Zn, and Pb for 30 min, followed by thorough rinsing before characterization with XPS.

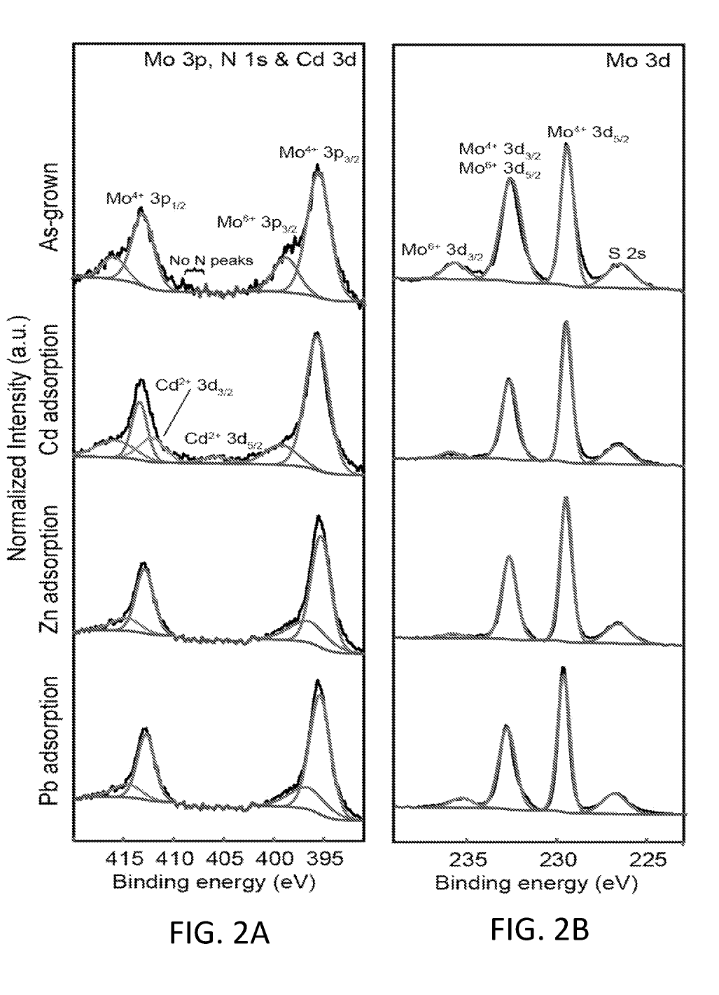

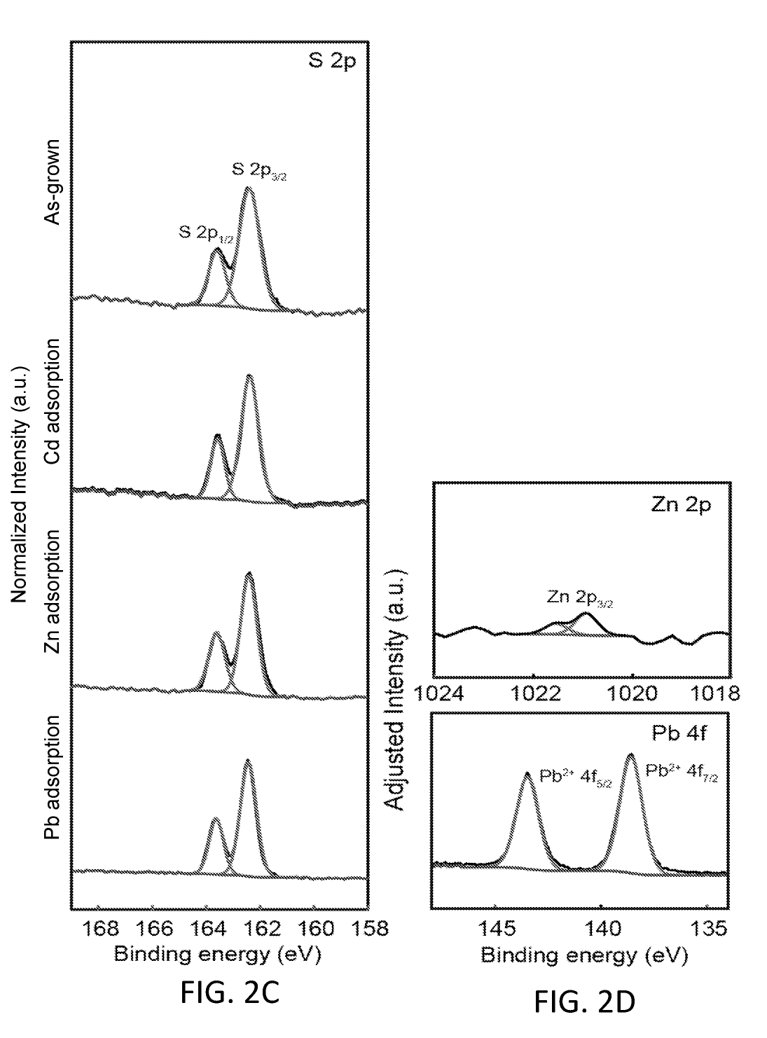

FIGS. 2A-2D show X-ray photoelectron spectroscopy (XPS) spectra of MoS₂ grown by chemical vapor deposition from top to bottom: as-grown, and after immersion in aqueous solutions of Cd, Zn and Pb nitrates, respectively, at 10 mM concentrations for 30 min. The spectra are vertically offset for clarity. FIG. 2A shows Mo3p, N 1s, and Cd 3d peaks. FIG. 2B shows Mo 3d peaks. FIG. 2C shows S 2p peaks. The intensities in FIGS. 2A-2C are normalized to the Mo⁴⁺3p_{3/2}, Mo⁴⁺3d_{5/2}, and S 2p_{3/2} peaks, respectively. Mo 3d and S 2p peaks do not change much in FIGS. 2A-2C. FIG. 2D shows Zn 2p peaks (upper) and Pb 4f peaks (lower). The intensities in FIG. 2D are adjusted to show the peaks more clearly. Cd, Zn and Pb peaks were detected after adsorption of the respective metal ions, whereas N peaks are absent. These results show that the MoS₂ material is largely unaffected by the metal nitrate solutions based on the similar intensities, positions, and shapes of the Mo⁴⁺3d_{3/2} peak, Mo⁴⁺3d_{5/2} peak, and S peaks as confirmed by the results in FIGS. 2B and 2C. In addition, Mo⁶⁺ was also detected since the precursors for CVD growth of MoS₂ included MoO₃. In FIG. 2C, the S 2p_{3/2} peak comes from MoS₂, whereas the S 2p_{1/2} peak may partially come from the S powder precursor. In FIG. 2A, compared to as-grown MoS₂, there are no N peaks emerging around 408.3 eV, which is reported to be the typical position of the nitrooxy (—O—NO₂) peak. Thus, substantially all of the nitrate was washed away during the rinsing step and did not adsorb to the MoS₂ surface.

In the second row of FIG. 2A, the binding energy ranges of Mo 3p, N, and Cd 3d partially overlap. Two components of Cd²⁺ were identified in the second row of FIG. 2A, demonstrating the presence of Cd on the MoS₂ surface. The smaller component around 405 eV most likely originates from Cd 3d_{5/2}. The asymmetric peak at ˜412 eV is clearly different from that of the as-grown MoS₂, with another component that is likely from Cd 3d_{3/2}.

In addition, clear Pb 4f peaks and Zn 2p peaks are shown in FIG. 2D, indicating the presence of Pb and Zn on MoS₂ surfaces of the samples immersed in those metal solutions. The absence of peaks due to covalent chemical bonds suggests that Zn is physisorbed to MoS₂ without strong bonding. According to density functional theory (DFT) calculations, the adsorption energy of Zn is small and may be related to the fully filled 3d orbitals. This observation is also supported by the weak intensity of Zn 2p peaks compared to the background. The intensity of Cd 3d_{5/2} is also weak and may be related to Cd having a similar electron configuration as Zn. However, the Cd—S bonding peak is around 405.3 eV, and the Pb—S bonding peak is around 137.8 eV, which are observed in the XPS results in FIGS. 2A and 2D, respectively. It is likely that there are more 3d electrons from Cd and 4f electrons from Pb transferred to MoS₂ compared to 2p electrons transferred from Zn. Therefore, these observations indicate Pb and Cd are more likely to be chemisorbed on MoS₂.

Another possible explanation for the adsorption is supported by the reaction between Lewis acids and 2D materials. At the top layer of MoS₂, each S atom possesses a tetrahedral electron configuration because of sp³ hybridization. Three of the sp³ orbitals form Mo—S bonds while the fourth is occupied by a lone pair of electrons to form a Lewis base. Therefore, heavy metal ions, as typical Lewis acids which can accept donated unshared electron pair, will react with 2D MoS₂. In this theory, Pb²⁺ as a Lewis acid can accept the lone pair electrons on MoS₂ surface due to its empty 6p orbitals and form stable coordinate covalent bonds.

The adsorption of metal ions as nanoparticles on MoS₂ nanoflakes described in the AFM and XPS results above demonstrate that MoS₂ is a suitable active agent in removing heavy metal pollutants from aqueous solution. The adsorbent material may also be regenerated and re-used, and is therefore advantageously efficient and economical as a water purification technology. Desorption of metals from the MoS₂ surface demonstrated the use of MoS₂ as a reusable adsorbent.

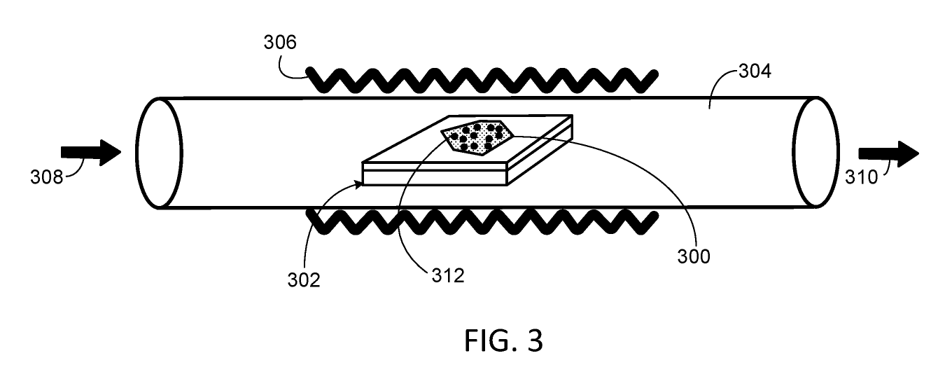

FIG. 3 depicts methods and experimental setups described herein. A sample of MoS₂ 300 on substrate 302 was heated in tube furnace 304 with heating coils 306 under ultrahigh purity Ar gas flow 308 at 300° C. for 2 hours and vacuum 310, followed by AFM imaging. Metal clusters 312 were adsorbed on MoS₂ 300.

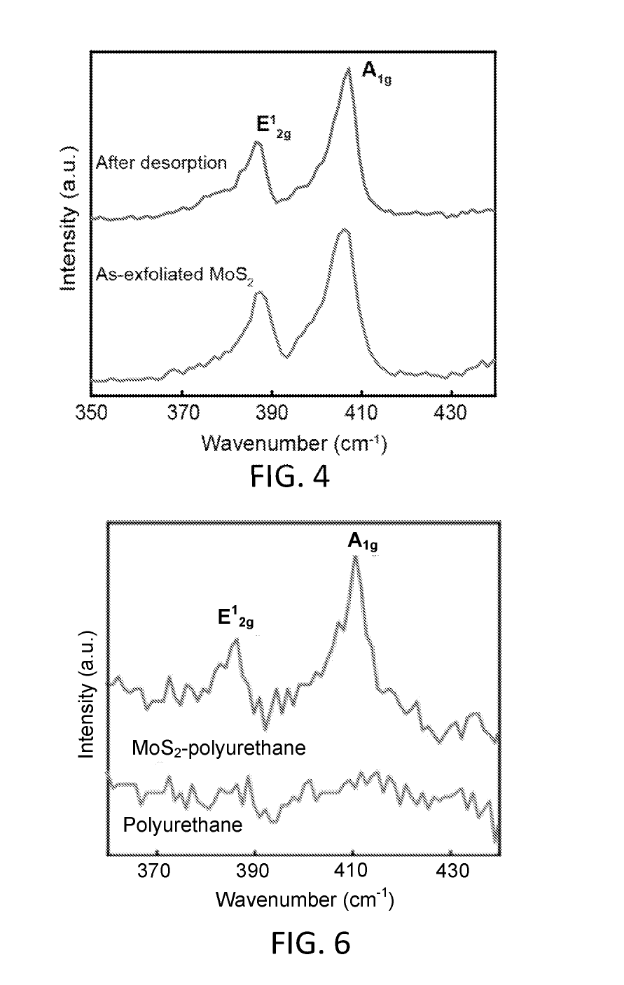

In one example, a sample with Pb clusters adsorbed was annealed, which resulted in the previously adsorbed Pb clusters being removed without damaging the MoS₂ surface. FIG. 4 shows Raman spectra of pristine as-exfoliated MoS₂ monolayer (lower curve) and Pd adsorbed MoS₂ monolayer after thermal desorption (upper curve). The characteristic E¹_{2g} and A_{1g} peaks of MoS₂ are marked. These spectra demonstrate the structural integrity of MoS₂ after desorption of metals.

The same sample was then immersed in aqueous solutions of Pb(NO₃)₂ at a concentration of 0.1 mM to test its ability to readsorb Pb. Even more Pb protrusions were observed on MoS₂ surface demonstrating the reusability of MoS₂, suggesting its potential to be used as a regenerable adsorbent. The same protocol of desorption was applied to exfoliated MoS₂ after exposure to Zn and Cd nitrate aqueous solutions; almost all of the previously adsorbed Cd and Zn was removed. A control experiment of Pb desorption at 180° C. was conducted without changes in all other parameters. Even though complete removal was not achieved, a considerable amount of Pb was still removed from the MoS₂ surface. This lower adsorption temperature will help to reduce the cost of desorption in potential future applications and expand the variety of the materials which can be combined with MoS₂.

Control experiments with mechanically exfoliated monolayer graphene were conducted using the same protocol as described above, as an analogue to carbon-based water purification technologies such as activated carbon and other graphene-based adsorbents. While both Zn and Cd are readily adsorbed on graphene, thermal annealing was ineffective for removing the metals. Compared to MoS₂, metals adsorbed on graphene cannot be easily removed, indicating that it is difficult to regenerate a graphene-based adsorbent for the removal of heavy metals. Based on this convenient thermal desorption procedure, MoS₂ iwater purification as a reusable adsorbent material that can be regenerated by heating, making it a sustainable and cost-effective solution. Throughout these various processes in both liquid phase and gas phase, the MoS₂ material remains stable and is not significantly changed.

As described herein, the 2D MoS₂ is engineered into a more robust, porous 3D macroscopic structure. Unlike atomically thin membranes with nanopores, the fabricated composites have interconnected microscopic hollow spaces to form a 3D porous structure that is structurally and mechanically robust. Polyurethane foam composites were synthesized by combining solution phase dispersions of MoS₂ with a polyol precursor solution as schematically illustrated in FIG. 5. A typical polyurethane foam synthesis involves a polycondensation reaction between a trifunctional polyol and a diisocyanate in the presence of a surfactant, catalyst and blowing agent. Here, an aqueous MoS₂ dispersion 500 was added as a blowing agent to a polyol solution 502 containing a surfactant and catalyst, and a diisocyanate was added to induce room temperature polymerization and foaming. The composition was dried to yield polymer foam 504 with embedded 2D material flakes 506. Polyurethane was chosen as the polymer matrix at least in part because it is a commonly used and chemically inert foam material, with no exposure limits as established by the Occupational Safety and Health Administration (OSHA) or the American Conference of Governmental Industrial Hygienists (ACGIH), and because it is mechanically robust.

In one example, solution 500 is a solution phase dispersion of MoS₂ flakes in sodium dodecyl benzenesulfonate (SDBS). The dispersion may be dark green due to the high concentration of MoS₂ flakes. The nanoflakes are typically between about 4 nm and 10 nm in thickness and between about 50 nm and a few hundred nanometers in length. A plain polyurethane foam and one with MoS₂ embedded throughout were prepared. The polyurethane foam is white while MoS₂-polyurethane foam is green due to the presence of MoS₂. The change in color indicates that MoS₂ flakes have been uniformly distributed and embedded. FIG. 6 shows Raman spectra taken from MoS₂-polyurethane composite foam (upper curve) and unmodified polyurethane foam (lower curve). The characteristic E¹_{2g} and A_{1g} peaks of MoS₂ are marked. SEM images of polyurethane foam and MoS₂-polyurethane foam show that both foams have a porous structure, which provides high surface areas that are favorable in an adsorbent material.

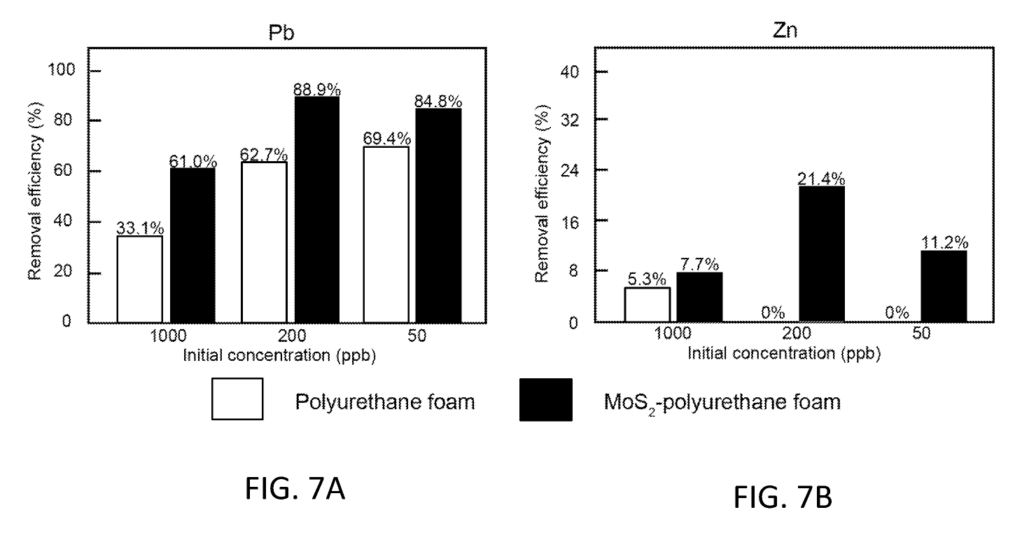

Batch adsorption experiments were conducted to study the performance of the MoS₂-polyurethane foam for removing metal ions from water. In all experiments, 0.5 g of adsorbent samples were immersed in metal-free centrifuge tubes with 7 mL of metal nitrate aqueous solutions to reach equilibrium at three initial concentrations. FIGS. 7A and 7B show the removal efficiency of Pb and Zn, respectively, at 1000, 200 and 50 ppb concentrations. The removal efficiencies were calculated as the ratio of the metal ion concentrations before and after adsorption, which were measured by inductively coupled plasma mass spectrometry (ICP-MS). Control experiments with polyurethane foam alone shows that it also has some adsorptive affinity for the metal ions. In the case of Pb, the embedded MoS₂ improved the adsorptive properties since the removal efficiency is much higher at all tested concentration levels. The removal efficiency of MoS₂-polyurethane foam at 1000 ppb was 61% which is nearly twice the efficiency of the polyurethane-only foam, and it also increased by 26.2 and 15.4 percentage points at 200 ppb and 50 ppb, respectively, as shown in FIG. 7A. At the 200 ppb and 50 ppb concentrations, 88.9% and 84.8% of the Pb was removed, respectively. For Zn, the MoS₂-polyurethane foam also has higher removal efficiency, especially at 200 ppb and 50 ppb, where the polyurethane-only foam was not able to remove any Zn, as shown in FIG. 7B.

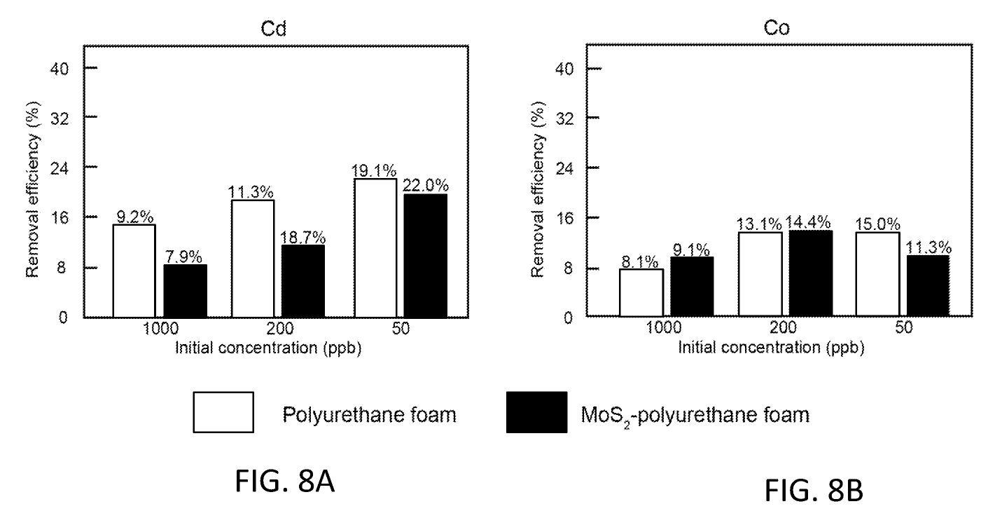

In additional experiments with Co and Cd, significant improvements in removal efficiency were not observed by adding MoS₂ to the polyurethane, as shown by FIGS. 8A and 8B, despite evidence of adsorption of metal clusters on MoS₂ from AFM measurements. For FIGS. 8A and 8B, ICP-MS was used to measure the metal ion concentrations of aqueous solutions before and after adsorption with MoS₂-polyurethane foams. Removal efficiencies are shown for polyurethane foam alone MoS₂-polyurethane composite. The initial concentrations were 1000, 200 and 50 ppb. Adsorption efficiencies were calculated as ion concentration after adsorption divided by initial concentration.

These results show that both types of foam have selectivity for Pb and Zn, with the addition of MoS₂ improving the adsorption efficiency. The EPA limit for Pb in drinking water is 15 ppb, and the synthesized foam composite can be applied as an adsorbent for removing Pb at concentrations lower than trace levels (concentrations below 100 ppm), which is an improvement over many conventional adsorbents for removing Pb which are usually more effective at concentrations in the ppm range. The thermal desorption of metals for regenerating the adsorbent can be also pursued via joule heating of the entire foam structure.

Thus, the adsorption of Pb, Cd, Zn, and Co on MoS₂ from nitrate solutions has been demonstrated with AFM, SEM, and XPS. The metal ions were adsorbed onto the surface of MoS₂ as small nanoclusters, while the nitrates were rinsed away. The metal nanoclusters were desorbed from MoS₂ by thermal annealing, demonstrating use of MoS₂ as a regenerable adsorbent. The synthesized MoS₂-polyurethane composite foam showed effective removal of Pb from water, especially at concentrations below 200 ppb, where 85-89% removal of Pb was achieved.

### Experimental Methods

Atomically thin MoS₂ samples were obtained by mechanical exfoliation from a bulk crystal of MoS₂ (SPI Supplies) by using scotch tape, and deposited onto a Si substrate coated with a 300 nm SiO₂ layer. The substrate was initially cleaned in sequential baths of acetone and 2-propanol, and blown dry with ultrahigh purity nitrogen before MoS₂ exfoliation. Single layer and multilayer MoS₂ flakes were identified by optical microscopy and Raman spectroscopy. As-exfoliated MoS₂ samples were immersed in aqueous solutions of heavy metal nitrates for 30 min. The solutions were made from Pb(NO₃)₂ (Sigma-Aldrich, ACS reagent, ≥99.0%), Cd(NO₃)₂ (Sigma-Aldrich, purum p.a., ≥99.0%), Zn(NO₃)₂ (Sigma-Aldrich, reagent grade, 98%), and Co(NO₃)₂ (Sigma-Aldrich, ACS reagent, 98%) in micropure water (18 MΩ). After rinsing thoroughly with micropure water, samples were blown dry with ultrahigh purity nitrogen. Atomic force microscope (AFM) images were taken before and after the metal ion exposure to detect the adsorption of metals forming into particles and islands.

The SiO₂/Si growth substrate was sonicated in sequential baths of acetone and 2-propanol for 5 min each, followed by oxygen plasma cleaning (Harrick Plasma, PDC-32G) at high RF power (18 W). The growth was conducted in a horizontal tube furnace (ThermoFisher Lindberg) with 1-inch diameter quartz tube. The precursors were 100 mg of S powder (Alfa Aesar, precipitated, 99.5%) placed at the end of the heating coils at an upstream position, and 15 mg of MoO₃ (Sigma-Aldrich, ACS reagent, ≥99.5%) placed in a boat bent from Mo foil at the center of the heating zone. The polished surface of the SiO₂/Si growth substrate was placed face down across the Mo boat. The furnace was heated at 650° C. for 30 min in vacuum with 300 sccm flow of ultrahigh purity Ar, followed by opening the furnace lid and cooling by an external fan.

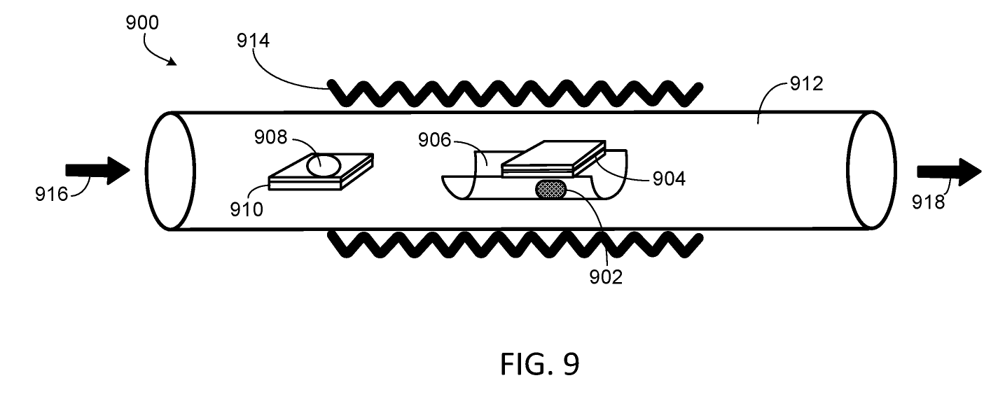

FIG. 9 depicts growth setup 900 with MoO₃ 902, SiO₂/Si substrate 904, Mo foil boat 906, sulfur 908, and platform 910 in tube furnace 912 with heating coils 914. Argon gas flow 916 is provided to a first end of tube furnace 912, and vacuum 918 is pulled on a second end of the tube furnace. The MoS₂ samples exposed to metal nitrate solutions were annealed in tube furnace, such as tube furnace 912, with a 1-inch diameter quartz tube at 300° C. for 2 hrs with a flow of 200 sccm of ultrahigh purity Ar as a carrier gas followed by AFM imaging.

13.1 g of 4,4′-methylenebis(phenylisocyanate) (Sigma-Aldrich, MDI, 98%) flakes were crushed into powder in a weigh boat. Then, 0.4 g of silicone oil (Sigma-Aldrich, Dow Corning 200® fluid, viscosity 60,000 cSt @ 25° C.) and 20 mL glycerol propoxylate-block-ethoxylate (Sigma-Aldrich, average M_{W}˜4000) were mixed into an HDPE beaker. Next, 0.7 mL of water and 0.188 mL of dibutyltin dilaurate (Sigma-Aldrich, 95%) were added to the HDPE beaker and the mixture was stirred. The MDI was added to the mixture, which was then rapidly mixed and left undisturbed. After about 1 hour, the foam was taken out and put in an oven set at ˜60° C. to dry overnight.

The same procedure as above was used, except that in place of 0.7 mL of water, 0.7 mL of a solution phase dispersion of MoS₂ in 1% w/v sodium dodecyl benzenesulfonate (SDBS technical grade) was used. To prepare the dispersion, 1.0 g MoS₂ powder (Sigma-Aldrich, <2 μm, 99%) was mixed with 6 mL of 1% w/v SDBS and tip sonicated in a Branson Sonifier 450 (tip diameter 3 mm) for 1 hour at 20% amplitude. The resulting sonicated dispersion was centrifuged at 5000 RCF for 4 minutes and the supernatant dispersion was extracted.

Pb, Cd, Zn, and Co nitrate solutions were prepared at 1000 ppb, 200 ppb and 50 ppb concentrations to test the performance of the polymer composite at different levels of contamination. In each experiment, 0.5 g of the MoS₂-polyurethane composite was immersed in 7 mL of metal nitrate aqueous solutions in metal-free centrifuge tubes for 12 hours. The solutions were shaken thoroughly before and after the adsorption. Aliquots of the aqueous solutions were taken with plastic pipettes and diluted to proper concentrations with 0.32 M HNO₃ (BDH Aristar Plus, trace metal analysis, 67-70%) aqueous solution for acidification and measured by ICP-MS (ThermoFisher ELEMENT 2). The unmodified polyurethane foam was tested with the same protocol.

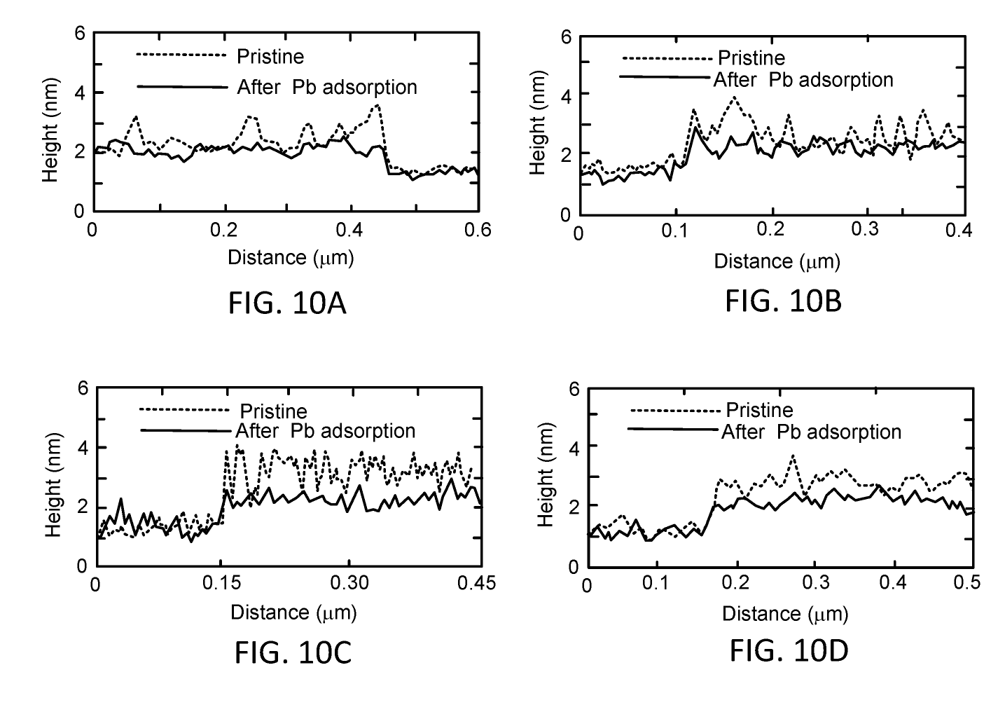

The adsorption of Pb from aqueous solutions of different concentrations was also studied. Concentrations of 100 ppb, 20 ppm, 100 ppm, and 500 ppm of Pb were used. In each case, a different sample of MoS₂ exfoliated on SiO₂/Si was immersed into the solution, and then rinsed with water and dried before AFM imaging. The AFM images show small isolated Pb particles are adsorbed onto MoS₂ at 100 ppb, and a higher surface concentration of the particles are seen at 20 ppm. For the 100 ppm and 500 ppm solutions, the surface concentration of particles appears to have saturated and become quite uniform. FIGS. 10A-10D show height profiles along selected lines in the AFM images before (lower trace) and after (upper trace) Pb adsorption for solutions having a lead concentration of 100 ppb, 20 ppm, 100 ppm, and 500 ppm, respectively.

The MoS₂ flakes were also immobilized in chitosan composite beads. These composite beads were then packed into a column for adsorption tests and for practical adsorbent devices. The MoS₂/chitosan composites were prepared using two different methods. In the first method, MoS₂ powders were directly mixed into a chitosan solution as follows: 0.33 g chitosan (crab chitosan) was dissolved in 0.1 M hydrochloric acid (HCl) solution, 50 mg MoS₂ powder was directly mixed with chitosan/HCl solution and stirred overnight. The mixed solution was dropped into 0.1 M sodium hydroxide (NaOH) solution to form beads and stirred overnight. The beads were rinsed using deionized (DI) water and dried in air to yield chitosan xerogel beads. In the second method, the MoS₂ and chitosan were sonicated together as follows: 20 g 3% wt. chitosan (low molecular weight) was dissolved in 1% glacial acetic acid, and 0.650 g of MoS₂ was added. Tip sonication was conducted for 1 hour, 35%, followed by full speed centrifugation (21130 rcf) for 45 min. A control was prepared with no MoS₂. The dispersions were dropped from a syringe needle into gently stirred 0.4 M NaOH and allowed to harden overnight. The beads were dehydrated for 10 minutes each in 10%, 30%, 50%, 90%, and 100% ethanol solutions and soaked in anhydrous ethanol solutions twice for 3-5 minutes each time. The beads were then subjected to supercritical CO₂ drying to yield aerogel beads.

A number of embodiments have been described. Nevertheless, it will be understood that various modifications may be made without departing from the spirit and scope of the disclosure. Accordingly, other embodiments are within the scope of the following claims.

What is claimed is:

1. A method for removing heavy metal ions from an aqueous composition, the method comprising:
contacting an aqueous composition comprising a heavy metal with nanoflakes comprising MoS₂ for a length of time sufficient to form nanoclusters of the heavy metal on the nanoflakes.

2. The method of claim 1, further comprising heating the nanoflakes to desorb the heavy metal from the nanoflakes.

3. The method of claim 2, wherein heating the nanoflakes comprises heating the nanoflakes to a temperature of at least 200° C. for at least one hour in an inert atmosphere.

4. The method of claim 1, wherein the nanoflakes comprise monolayer, bilayer, or trilayer MoS₂.

5. The method of claim 4, wherein the nanoflakes are coupled to a porous polymer matrix.

6. The method of claim 5, wherein the porous polymer matrix comprises polyurethane.

7. The method of claim 5, wherein the porous polymeric matrix comprises a biopolymer.

8. The method of claim 7, wherein the biopolymer comprises one or more of chitosan, alginate, and cellulose.

9. The method of claim 1, wherein the heavy metal comprises one or more of lead, zinc, cadmium, and cobalt.

10. The method of claim 1, wherein a concentration of the heavy metal in the aqueous composition is between 100 parts per billion and 500 parts per million, or between 100 parts per billion and 100 parts per million.

11. The method of claim 1, wherein the nanoclusters have a dimension in a range between 2 nm and 100 nm.

12. The method of claim 1, wherein at least 50 wt % of the heavy metal is removed from the aqueous composition.

13. The method of claim 12, wherein at least 70 wt % of the heavy metal is removed from the aqueous composition.

14. The method of claim 13, wherein at least 90 wt % of the heavy metal is removed from the aqueous composition.

15. A composite comprising:
a porous polymeric matrix; and
MoS₂ nanoflakes coupled to the porous polymeric matrix.

16. The composite of claim 15, wherein the porous polymeric matrix comprises polyurethane.

17. The composite of claim 15, wherein the porous polymeric matrix comprises a biopolymer.

18. The composite of claim 17, wherein the biopolymer comprises one or more of chitosan, alginate, and cellulose.

19. The composite of claim 18, wherein the biopolymer comprises chitosan, and the composite is in the form of chitosan-containing beads.

20. The composite of claim 19, wherein the chitosan-containing beads are in the form of a xerogel or an aerogel.

21. A method of making a porous MoS₂-polymer composite, the method comprising:
combining a solution phase dispersion of MoS₂ with a polymer precursor solution to yield a mixture;
treating the polymer precursor solution to yield a composite precursor; and
drying the composite precursor to yield a porous MoS₂-polymer composite.

22. The method of claim 21, wherein the polymer precursor solution comprises chitosan.

23. The method of claim 22, wherein the porous MoS₂-polymer composite is in the form of an aerogel.
